(19) United States
(12) Patent Application Publication
(10) Pub. No.: US 2004/0222374 A1
(43) Pub. Date: Nov. 11, 2004

(54) Ion detector array assembly and devices comprising the same

(76) Inventors: Adi A. Scheidemann, Seattle, WA (US); Mark McGraw, Lynnwood, WA (US); Eustathios Vassiliou, Newark, DE (US)

Correspondence Address: EUSTATHIOS VASSILIOU, 12 SOUTH TOWNVIEW LANE, NEWARK, DE, 19711, US

(21) Appl. No.: 10/811,576

(22) Filed: Mar. 29, 2004

Related U.S. Application Data
(60) Provisional application No. 60/468,780, filed on May 7, 2003.

(51) Int. Cl. H01J 49/32

(52) U.S. Cl. 250/299; 250/296

(57) ABSTRACT

A spectrometer assembly comprising an ion detector array and a printed circuit board, wherein the ion detector array is attached on the printed circuit board, and the printed circuit board is secured on the same base plate that a magnetic section is secured. This configuration presents many advantages including, but not limited to, sturdy and convenient electrical connections between the assembly and following processing units, as well as mounting accuracy of the ion detector array in miscellaneous devices, and especially in front of magnetic sectors of spectrometers of the Mattauch and Herzog type. This invention pertains any types of ion detector arrays, with special emphasis to Strip Charge Detector Arrays, Faraday Cup Detector Arrays, and even more importantly to Shift Register Based Direct Ion Detection Chips. The present invention further pertains Mass Spectrometers (MS), combination of Mass Spectrometers with other Mass Spectrometers (MS/MS), as well as combinations of Gas Chromatographs with Mass Spectrometers (GC/MS), as long as thy comprise the Detector-PCB of this invention.

### RELATED APPLICATIONS

This application claims priority of provisional patent application 60/468,780 filed on Apr. 2, 2003, which is incorporated herein by reference in its entirety.

### FIELD OF THE INVENTION

This invention pertains assemblies of ion detector arrays, and more particularly assemblies of ion detector arrays in double focusing mass spectrometers, as well as any other devices comprising such assemblies.

### BACKGROUND OF THE INVENTION

Mass spectrometry is widely used in many applications ranging from process monitoring to life sciences. Over the course of the last 60 years, a wide variety of instruments have been developed. The focus of new developments has been two fold: (1) a push for ever higher mass range with high mass resolution and MS/MS capability, and (2) on developing small, desktop MS instruments.

Mass spectrometers are often coupled with gas chromatographs (GC/MS) for analysis of complex mixtures. This is especially the case for volatile compound (VOC) and semi-volatile compound (semi-VOC) analysis. A GC/MS instrument typically has a gas inlet system (the GC would be part of this), an electron impact based ionizer [EI] with ion extractor, some optic elements to focus the ion beam, ion separation, and ion detection. Ionization can also be carried out via chemical ionization.

Ion separation can be performed in the time or spatial domain. An example for mass separation in the time domain is a time of flight mass spectrometer. Time domain separation is seen in commonly used quadrupole mass spectrometers. Here the “quadrupole filter” allows only one mass/charge ratio to be transmitted from the ionizer to the detector. A full mass spectrum is recorded by scanning the mass range through the “mass filter”. Other time domain separation is based on magnetic fields where either the ion energy or the magnetic field strength is varied, again the mass filter allowing only one mass/charge ratio to be transmitted and a spectrum can be recorded through scanning through the mass range.

An alternative concept is a mass spectrograph in which the ions are spatially separated in a magnetic field and detected with a position sensitive detector. The concept of a double focusing mass spectrograph was first introduced by Mattauch and Herzog (MH) in 1940 (J. Mattauch, Ergebnisse der exakten Naturwissenschaften, vol 19, page 170-236, 1940, which is incorporated herein by reference in its entirety).

Double focusing refers to the instrument's ability to refocus both the energy spread as well as the spatial beam spread. Modern developments in magnet and micro machining technologies allow dramatic reductions in the size of these instruments. The length of the focal plane in a mass spectrometer capable of VOC and semi-VOC analysis is reduced to a few centimeters.

The typical specifications of a small confocal plane layout Mattauch-Herzog instrument are summarized below:

Electron impact ionization, Rhenium filament

DC-voltages and permanent magnet

Ion Energy: 0.5-2.5 kV DC

Mass Range: 2-200 D

Faraday cup detector array or strip charge detector

Integrating operational amplifier with up to 10^{Λ}11 gain

Duty Cycle: >99%

Read-Out time: 0.03 sec to 10 sec

Sensitivity: approximately 10 ppm with strip charge detector

In traditional instruments the ion optic elements are mounted in the vacuum chamber floor or on chamber walls. The optics can also be an integral part of the vacuum housing lay-out. In small instruments, however, the ion optics can easily be built on a base plate which acts as an “optical bench”. This bench holds all components of the ion optics. The base plate is mounted against a vacuum flange to provide the vacuum seal needed to operate the mass spectrometer under vacuum. The base plate can also be the vacuum flange itself.

The ion detector in a Mattauch-Herzog layout is a position sensitive detector. Numerous concepts have been developed over the last decades. Recent developments focus on solid state based direct ion detection as an alternative to previously used electro optical ion detection (EOID).

The electro optical ion detector (EOID) converts the ions in a multi-channel-plate (MCP) into electrons, amplifies the electrons (in the same MCP), and illuminates a phosphorus film with the electrons (emitted from the MCP). The image formed on phosphorus film is recorded with a photo diode array via a fiber optic coupler (see U.S. Pat. No. 5,801,380, which is incorporated herein by reference in its entirety). The electro-optic ion detector (EOID), is intended for the simultaneous measurement of ions spatially separated along the focal plane of the mass spectrometer. This device may operate by converting ions to electrons and then to photons. The photons form images of the ion-induced signals. The ions generate electrons by impinging on a microchannel electron multiplier array. The electrons are accelerated to a phosphor-coated fiber-optic plate that generates photon images. These images are detected using a photodetector array. The electro-optic ion detector (EOID), although highly advantageous in many ways, is relatively complicated since it requires multiple conversions. In addition, there may be complications from the necessary use of phosphors, in that they may limit the dynamic range of the detector. A microchannel device may also be complicated, since it may require high-voltage, for example 1 KV, to be applied. This may also require certain of the structures such as a microchannel device, to be placed in a vacuum environment such as 10⁶ Torr. At these higher pressures of operation, the microchannel device may experience ion feedback and electric discharge. Fringe magnetic fields may affect the electron trajectory. Isotropic phosphorescence emission may also affect the resolution. The resolution of the mass analyzer may be therefore compromised due to these and other effects.

According to a different configuration, a direct charge measurement can be based on a micro-machined Faraday cup detector array. Here, an array of individually addressable Faraday cups monitors the ion beam. The charge collected in individual elements of the array is handed over to an amplifier via a multiplexer unit. This layout reduces the number of amplifiers and feedthroughs needed. This concept is described in detail in recent publications, such as

“Robert B. Darling, Adi A. Scheidemann, K. N. Bhat, and T.-C. Chen, Micromachined Faraday Cup Array Using Deep Reactive Ion Etching, Sensors and Actuators, A95 (2002) 84-93”; “R. B. Darling, A. A. Scheidemann, K. N. Bhat, and T.-C. Chen,, Proc. of the 14 th IEEE Int. Conf. on Micro Electro Mechanical Systems (MEMS-2001), Interlaken, Switzerland, Jan. 21-25, 2001, pp. 90-93”; and Non-Provisional patent application Ser. No. 09/744,360 titled “Charged Particle Beam Detection System”; all three of which are incorporated herein by reference in their entirety.

Other important references regarding spectrometers are “Nier, D. J. Schlutter Rev. Sci. Instrum. 56(2), page 214-219, 1985; and T. W. Burgoyne et. al. J. Am. Soc. Mass Spectrum 8, page 307-318, 1997; both of which are incorporated herein by reference in their entirety.

Alternatively, especially for low energy ions, a flat metallic strip (referred to as a strip charge detector (SCD)) on a grounded and insulated background can be used to monitor the ion beam. Again the charge is handed over to an amplifier via a multiplexer.

A very important ion detector array is disclosed in U.S. Pat. No. 6,576,899, which is also incorporated herein by reference in its entirety. It may be referred to as a shift register based direct ion detector.

That application defines a charge sensing system which may be used, for example, in a Mass Spectrometer system, e.g. a Gas chromatography—Mass spectrometry (GC/MS) system, with a modified system which allows direct measurement of ions in a mass spectrometer device, without conversion to electrons and photons (e.g., EOID) prior to measurement. In one case, it may use charge coupled device (CCD) technology. This CCD technology may include metal oxide semiconductors. The system may use direct detection and collection of the charged particles using the detector. The detected charged particles form the equivalent of an image charge that directly accumulates in a shift register associated with a part of the CCD. This signal charge can be clocked through the CCD in a conventional way, to a single output amplifier. Since the CCD uses only one charge-to-voltage conversion amplifier for the entire detector, signal gains and offset variation of individual elements in the detector array may be minimized.

In a Mattauch-Herzog layout the detector array, composed of either Faraday cup detector array or strip charge detector, or any other type of the aforementioned detectors, has to be placed at the exit of the magnet. This position is commonly referred to as the “focal plane”.

The Faraday cup detector array (FCDA) can be made by deep reactive ion etching (DRIE). The strip charge detector (SCD) can be made by vapor deposition. The dice with the active element (FCDA or SCD) is usually cut out of the wafer with conventional techniques such as laser cutting or sawing.

The FCDA or SCD dice needs to be held in front of the magnet and electronically connected to the multiplexer and amplifier unit called “Faraday Cup Detector Array”—“Input/Output”—“Printed Circuit Board” (FCDA-I/O-PCB) to read out the charge collected with the detector elements.

In traditional Mattauch-Herzog instruments the ion optics are placed on the vacuum chamber wall, and the position sensitive ion detector is mounted on the exit flange of the ion flight path. This arrangement is required as a result of having the magnet outside of the vacuum. The multiplexer and amplifier unit is also positioned outside of the vacuum chamber in the case of traditional Mattauch-Herzog instruments.

According to the present invention it is highly preferable that all parts of the ion optics are placed on the “base plate”, thus the position sensitive solid state based ion detector may be mounted against the same base plate using a printed circuit board (PCB). Further, the multiplexer and amplifier unit is also positioned inside of the vacuum chamber, which presents many advantages.

### SUMMARY OF THE INVENTION

This invention pertains spectrometer assemblies comprising ion detector arrays mounted on printed circuit boards. Such spectrometer assemblies are for example assemblies of ion detector arrays mounted on printed circuit boards in double focusing mass spectrometers, as well as any other devices comprising such assemblies. More particularly, this invention pertains a spectrometer assembly comprising:

a base plate;

a magnetic section mounted on the base plate and having an exit portion; and

a focal plane section disposed in front of the exit portion of the magnetic section, the focal section comprising an ion detector array assembly of a first printed circuit board mounted on the base plate and having traces, and an ion detector array attached to the first printed circuit board, the ion detector array having a plurality of ion sensing elements, wherein more than one of the ion sensing elements of the ion detector array are electrically connected to respective traces of the first printed circuit board directly or indirectly, thus rendering said respective traces active traces.

The connection may be direct in the case of strip charge or Faraday detectors, for example, or after indirect, such as for example in the case that the sensing elements and a CCD register are on the same microchip.

The first printed circuit board may further comprise one or more connectors selected form a group of direct connector and indirect connector, each connector being adaptable to connect or connecting active traces of the first printed circuit board with the input of a circuitry selected from a multiplexer and a combination of a multiplexer/amplifier.

The ion detector array may be a strip charge detector array, a faraday cup detector array, a shift register based direct ion detection chip array, or any other type of ion detector array.

The first printed circuit board may further comprise a circuit selected from a group of a multiplexer and a combination of multiplexer/amplifier connected to active traces of said first printed circuit board. Again, the ion detector array may be a strip charge detector array, a faraday cup detector array, a shift register ion detection chip array, or any other type of ion detector array.

In the case that the printed circuit board comprises a multiplexer or an amplifier or both, it is preferable that the ion detector array assembly also comprises a shield surrounding the printed circuit board, except of course the region where the ion detector array is located.

The assemblies described above may further comprise at least one additional printed circuit board disposed substantially parallel to and in the vicinity of the first printed circuit board and comprising a circuitry selected from multiplexer, amplifier, and combination of multiplexer/amplifier. Again, the ion detector array may be a strip charge detector array, a faraday cup detector array, a shift register ion detection chip array, or any other type of ion detector array. It is also preferable that this type of ion detector array assembly further comprises a shield surrounding all printed circuit boards, except of course the region where the ion detector array is located.

The present invention further pertains devices comprising a mass spectrometer of the Mattauch and Herzog type, the mass spectrometer comprising a spectrometer assembly comprising:

a base plate;

a magnetic section mounted on the base plate and having an exit portion; and

a focal plane section disposed in front of the exit portion of the magnetic section, the focal section comprising an ion detector array assembly of a first printed circuit board mounted on the base plate and having traces, and an ion detector array attached to the first printed circuit board, the ion detector array having a plurality of ion sensing elements, wherein more than one of the ion sensing elements of the ion detector array are electrically connected to respective traces of the first printed circuit board directly or indirectly, thus rendering said respective traces active traces.

Any assemblies described hereinabove may also be utilized at the focal plane section in front of the exit portion of the magnetic section of the spectrometer.

The device may further comprise any other instruments, such as for example, additional mass spectrometers, gas chromatographs, or other needed devices.

### BRIEF DESCRIPTION OF THE DRAWING

The reader's understanding of this invention will be enhanced by reference to the following detailed description taken in combination with the drawing figures, wherein:

FIG. 1 illustrates a schematic view of a Mattauch Herzog spectrometer connected to a gas chromatograph.

FIG. 2 is a photograph of the vacuum portion of a miniaturized Mattauch Herzog spectrometer, including a vacuum flange, base plate, an ionizer, an electro static energy analyzer, a magnetic section, and a focal plane section, which according to the present invention is a detector-PCB (Printed Circuit Board).

FIG. 3 illustrates a perspective view of a similar Mattauch Herzog spectrometer as in FIG. 2, including a vacuum flange, base plate, an ionizer, an electro static energy analyzer, and a magnetic section. The detector-PCB is not shown.

FIG. 4 illustrates a schematic view of an electro optical ion Detector.

FIG. 5 is the photograph of a Strip Charge Detector (SCD) supported on and connected to a Detector Printed Circuit Board (DPCB).

FIG. 6 is the photograph of a magnified portion of FIG. 5 illustrating the wire bonding of a Strip Charge Detector (SCD) on a Detector Printed Circuit Board (DPCB). Preferably the wires shown in FIGS. 5 and 6 are coated by a protective layer, such as epoxy for example.

FIG. 7 is a photograph of an ion detector array assembly mounted on a Base Plate among other components, excluding the magnetic section for purposes of clarity.

FIG. 8 illustrates a schematic view of an ion detector array assembly comprising a first printed circuit board, and a strip charge detector, mounted on a base plate in front of a magnetic section according to one embodiment of the present invention. A second printed circuit board comprising the multiplexer and/or multiplexer amplifier is disposed under the base plate in this example.

FIG. 8A illustrates a schematic view of an ion detector array assembly, similar to the one of FIG. 8, with the difference that the first printed circuit board further comprises a multiplexer or a multiplexer/amplifier.

FIG. 8B illustrates a schematic view of an ion detector array assembly, similar to the one of FIG. 8, with the difference that the first printed circuit board assembly further comprises additional printed circuit boards in a parallel position to the first printed circuit board supporting a multiplexer and an amplifier.

FIG. 8C illustrates a schematic view of an ion detector array assembly, similar to the one of FIG. 8B, with the difference that all printed circuit boards are surrounded by an electrical shield.

FIG. 9 illustrates a schematic view of an ion detector array assembly comprising a first printed circuit board, and a strip charge detector, and mounted on a base plate in front of a magnetic section according to a different embodiment of the present invention.

FIG. 10 is a photograph of an FCDA-I/O-PCB (Faraday Cup Detector—Input/Output—Printed Circuit Board.

FIG. 11 illustrates a Mass Spectrum (Spectrogram) recorded with a Spectrometer of the present invention, wherein the Spectrometer has a 1″ long Focal Plane.

FIG. 12 is a magnified version of the Spectrogram of FIG. 11.

### DETAILED DESCRIPTION OF THE INVENTION

As aforementioned, this invention pertains spectrometer assemblies comprising ion detector arrays mounted on printed circuit boards. Such spectrometer assemblies are for example assemblies of ion detector arrays mounted on printed circuit boards (PCB's) in double focusing mass spectrometers, as well as any other devices comprising such assemblies, which may or may not be combined with gas chromatography apparatuses, or any other apparatuses.

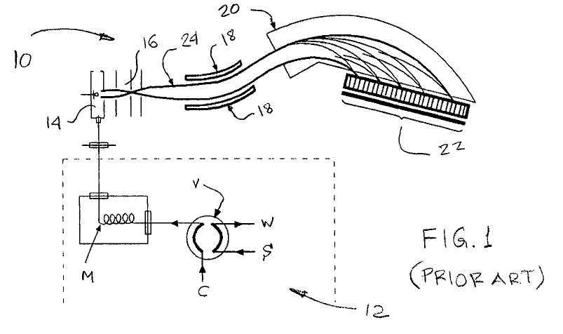

Referring now to FIG. 1, there is depicted a schematic diagram of a double focusing mass spectrometer (Mattauch-Herzog layout) 10, along with a separate preceding unit of a gas chromatograph apparatus 12.

The double focusing mass spectrometer 10 comprises an ionizer 14, a shunt and aperture 16, an electro static energy analyzer 18, a magnetic section 20, and a focal plane section 22.

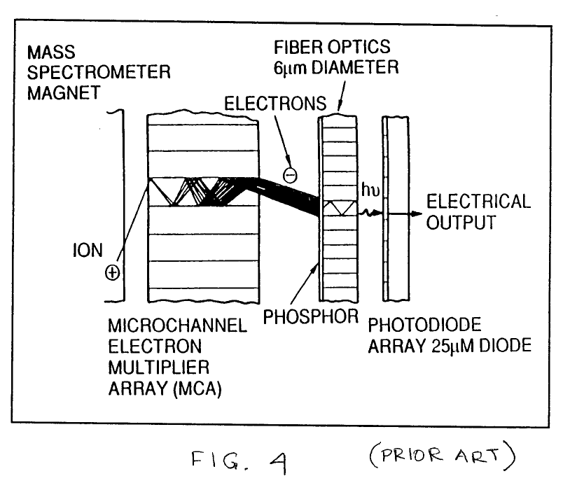

In the operation of a mass spectrometer (MS), gaseous material or vapor is introduced into the ionizer 14, either directly or through the gas chromatograph 12 (for complex mixtures or compounds), where it is bombarded by electrons, thus producing ions, which ions are focused in the shunt and aperture section 16 forming an ion beam 24. In sequence, they are rendered to have the same kinetic energy and separated according to their charge/mass ratio in the electro static energy analyzer 18, and the magnetic section 20, respectively. They are then detected in the focal plane section 22, as shown for example in FIG. 4 and as disclosed for example in U.S. Pat. No. 5,801,380, which is incorporated herein by reference. The process takes place under vacuum of the order of about 10⁻⁵ Torr with a use of a vacuum pump (not shown).

The gas chromatograph (GC) 12, in this specific example (although a liquid injector is considerably more common), comprises a sample injector valve V, which has an entry port S for introduction of the sample, an exit port W for the waste after the sample has been vaporized and/or decomposed, typically by heat, and the part to be analyzed (referred to as analyte) is carried by a carrier gas, such as dry air, hydrogen, or helium, for example, to a capillary column M (wall coated open tubular, or porous layer open tubular, or packed, etc.), where its constituents are separated by different absorption rates on the wall of the microbore column M, which has a rather small inside diameter, of the order of about 50-500 μm for example. The carrier gas flows typically at 0.2 to 5 atm. cm³/sec, although higher flows, such as for example 20 atm. cm³/sec are possible. In sequence, the miscellaneous constituents of the sample enter the ionizer for further spectrometric analysis as described above.

The larger the bore of the capillary tube the larger the vacuum pump is necessary, and the smaller the bore the narrower the peaks of the effluent resulting to a large loss of signal. Thus, a compromise has to be decided. This problem has been addressed by U.S. Pat. No. 6,046,451, which is incorporated herein by reference.

The mass spectrometers of the present invention are very fast, so that even with narrow peak widths, many slices may be collected to provide good performance, even with small capillary bores and small vacuum pumps.

Other patents representing major advances in the art of mass spectrometers (MS or GS/MS) are U.S. Pat. No. 5,317,151, U.S. Pat. No. 5,801,380, U.S. Pat. No. 6,182,831 B1, U.S. Pat. No. 6,191,419 B1, U.S. Pat. No. 6,403,956 B1, and U.S. Pat. No. 6,576,899 B2, among others, all six of which are incorporated herein by reference.

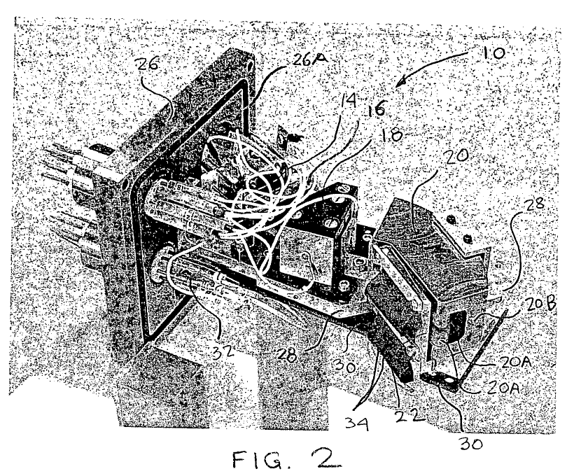

FIG. 2 is a photograph illustrating major components or the Mattauch-Herzog Sector 10 of a miniaturized mass spectrometer, which is a highly preferable configuration according to the present invention. A base plate 28 is supported on a vacuum flange 26, on the front face 26A of which flange 26 there is secured a vacuum chamber (not shown) to cover the vacuum space within which said major components are residing.

It is important to notice that all these components are supported on the base plate 28, which results in a very sturdy and accurate configuration.. In addition when you mount the components on the vacuum chamber wall, then the wall moves when vacuum is pulled due to differential pressure. Even slight movement can throw off delicate alignment. However, because the base plate in the case of the present invention is isolated from such movement and because the pressure is equal on all sides of the base plate by virtue of it being in the vacuum chamber, then the alignment is kept perfectly isolated from such negative effects.

A number of vacuum sealed input/output leads 32 are disposed on the vacuum flange 26 for communication purposes between components within the vacuum chamber (not shown) and other components outside said vacuum chamber.

An Ionizer 14 is secured on the base plate 28, close to the vacuum flange 26, with a shunt and aperture combination 16 in front of the ionizer 14. Further away from the flange 26, there is disposed an electrostatic energy analyzer 18, which is also secured on the base plate 28.

In sequence, a magnetic sector 20 is also secured on the base plate 28. The magnetic sector 20 comprises a yoke 20B and magnets 20A attached to the yoke 20B. It is highly desirable that the yoke has high magnetic flux saturation value. Therefore, a yoke 20B having a saturation value of at least 15,000 G is preferable, and more preferable is one having a saturation value of more than 20,000 G. Such yokes are made for example of hyperco-51A VNiFe alloy.

Regarding the magnet design, it should be noted that the volume and mass of a magnet is typically inversely proportional to the energy product value of the magnetic material. A typical magnetic material is Alnico V which has an energy product of about 5-6 MGOe. Other materials include, but are not limited to Sm—Co alloys and Nd—B—Fe alloys. Unfortunately, these alloys, and more particularly Nd—B—Fe alloys, have considerably higher sensitivity to temperature variations, and methods for temperature compensation may be necessary to avoid frequent instrument calibrations and other problems. One way to compensate for temperature variations is disclosed and claimed in U.S. Pat. No. 6,403,956 B1.

Finally, in FIG. 2, there is depicted a focal plane section 22, which, according to the present invention, is a printed circuit board (PCB) supporting a detector array in front of the magnet separation, which detector array can be of different configurations, as it will be discussed in details hereinbelow. Flex cable connectors 34 are used to connect said detector array with the multiplexer and amplifier unit 30, as it will be described also in detail hereinbelow.

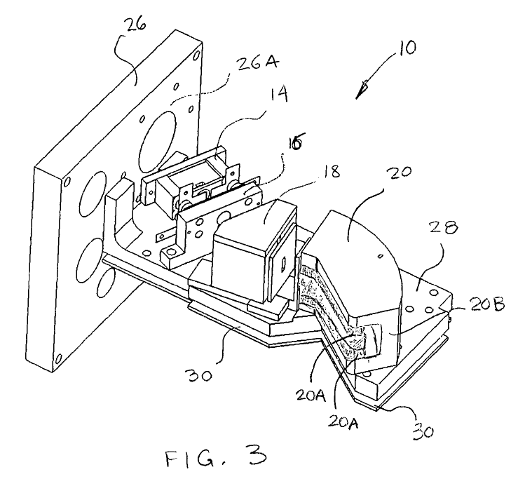

FIG. 3 illustrates a perspective view of the same vacuum section shown in FIG. 2, with the difference that the focal section 22 shown in FIG. 2 is missing in FIG. 3.

FIG. 4 illustrates a prior art electro optical ion detector, wherein ions of different mass units impinge from the mass spectrometer magnet onto respective micro-channels of a microchannel electron multiplier array (MCA) forming electrons, which electrons, as they bump on the walls of the micro-channels, are multiplied. The multiplied electrons exit the microchannel electron multiplier array and hit respective positions of a phosphor layer, which is attached to a fiber optics configuration, thus illuminating respective positions of a photodiode array, resulting in an electrical output.

As it can be realized and as aforementioned, this is a rather complicated process, since it involves multiple steps of forming electrons from positive ions, which electrons are changed to photons, and in turn the photons are finally changed to electric current.

As aforementioned, especially for low energy ions, a flat metallic strip (referred to as a strip charge detector (SCD)) on a grounded and insulated background can be used to monitor the ion beam. The charge is handed over to an amplifier via a multiplexer.

As also aforementioned, direct charge measurement can be based on a micro-machined Faraday cup detector array. An array of individually addressable Faraday cups monitors the ion beam. The charge collected in individual elements of the array is handed over to an amplifier via a multiplexer unit. This layout reduces the number of amplifiers and feedthroughs needed.

As further aforementioned, a very important ion detector array is disclosed in U.S. Pat. No. 6,576,899. It may be referred to as a shift register based direct ion detector.

That application defines a charge sensing system which may be used, for example, in a Mass Spectrometer system, e.g. a Gas chromatography—Mass spectrometry (GCMS) system, with a modified system which allows direct measurement of ions in a mass spectrometer device. This CCD technology may include metal oxide semiconductors. The system may use direct detection and collection of the charged particles using the detector. The detected charged particles form the equivalent of an image charge that directly accumulates in a shift register associated with a part of the CCD. This signal charge can be clocked through the CCD in a conventional way, to a single output amplifier. Since the CCD uses only one charge-to-voltage conversion amplifier for the entire detector, signal gains and offset variation of individual elements in the detector array may be minimized.

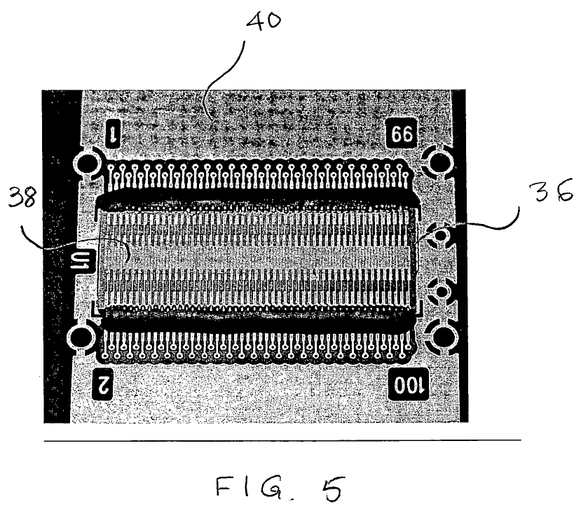

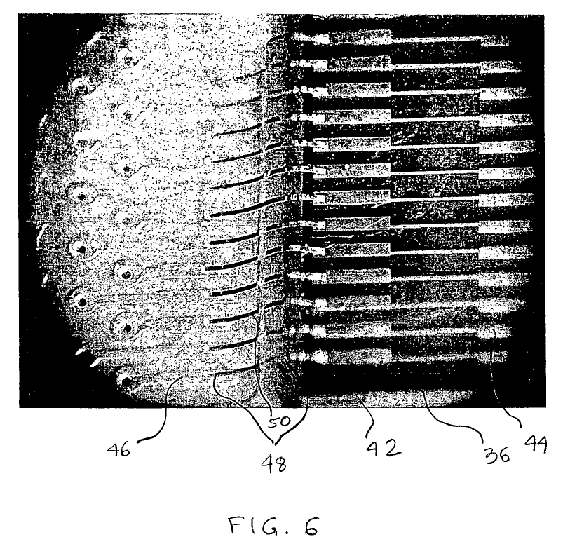

In one embodiment of the instant invention, as better shown in FIG. 5, the dice 36 with a strip charge detector (SCD) array 38 is glued to a first printed circuit board 40 (referred to as Detector-PCB). As better shown in FIG. 6, the leads 42 of more than one of the individual detector elements, or ion sensing elements 44 are wire bonded to the traces 46 on the first printed circuit board, or Detector-PCB 40, with bonding wires 50. It is preferable that the majority of leads 42, and even more preferable that all of the leads 42 are wire bonded to respective traces 46. The connected traces 46 are then considered to be active traces. The wire bonds 48 and the bonding wires 50 may preferably be buried in a protective layer, such as epoxy for example, so that the bonds 48 and bonding wires 50 are protected. Thus, the Detector-PCB 40 can connect the dice 36 (with the detector array) to the multiplexer/amplifier unit 30, in a very efficient, accurate, sensitive, and effective way, as compared to connecting directly the SCD array with the multiplexer/amplifier 30 in the absence of the Detector PCB 40.

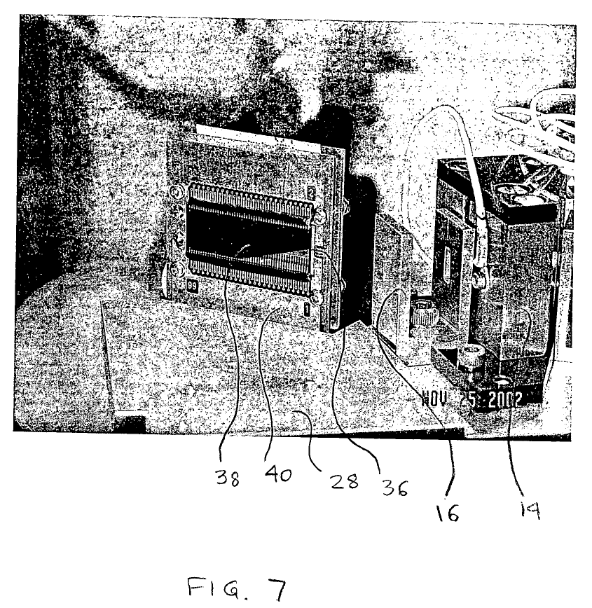

Further, as better illustrated in FIG. 7, since all components, including the Detector-PCB are mounted on the same base plate 28, extremely accurate positioning may be achieved resulting in optimal performance (e.g., optimal resolution). In FIG. 7, the magnetic sector 20 has been omitted for better demonstrating the positioning of other components.

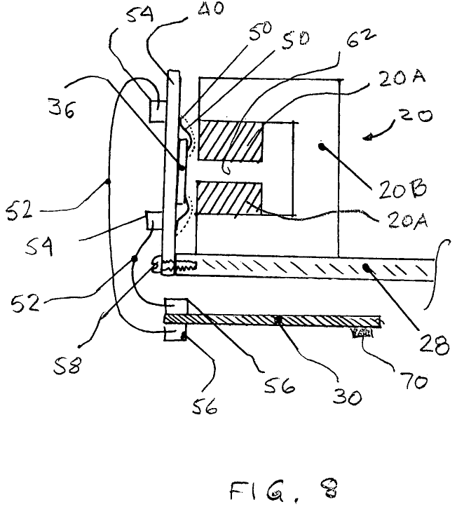

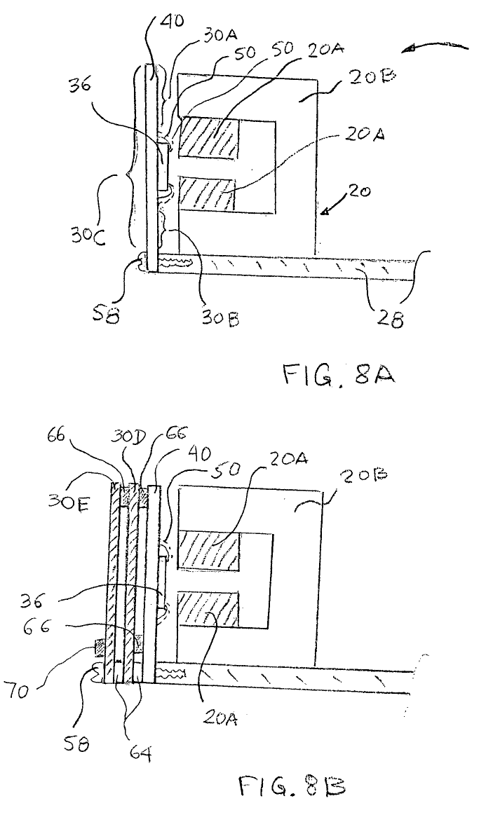

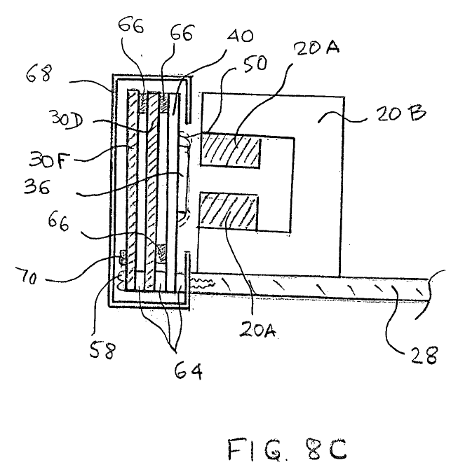

The combination of dice 36, detector-PCB 40, multiplexer/amplifier 30, magnetic section 20, and base plate 28 is better illustrated in FIG. 8.

The Detector-PCB 40 is precision mounted on the base plate 28 using a set of screws 58 to hold it on the base plate 28 in a precise position with respect to the magnetic sector 20. Further, guidance pins (not shown) may be inserted in the base plate 28, while the Detector-PCB provides mating holes (not shown).

The connection between the Detector-PCB 40 and the multiplexer/amplifier unit 30 may be done with flex cables 52. The flex cable connectors 54 on the Detector-PCB 40 are preferably on the backside (pointing away from the SCD array 36) of the Detector-PCB 40. The flex cable connectors 54 on the Detector-PCB 40 are considered to be indirect connectors because they do not directly connect the active traces 46 (see FIG. 6) of the first printed circuit board with the input 56 of a circuitry 30, such as a multiplexer or a combination of a multiplexer/amplifier, for example. It can be realized then, as also aforementioned, that the Detector-PCB fulfills a number of important tasks, among which, one is to hold the dice with the SCD array at a precise location in the focal plane of the mass spectrometer, and another to allow a convenient connection of the SCD array 36 (or other type of array) to the multiplexer/amplifier 30.

In operation of this embodiment, ions having different masses are separated in the magnet gap 62 and impinge on respective sections, such as the ion sensing elements of the SCD array 36. Charges induced on the sensing elements by the impinging ions are transferred by wires 50 to respective traces 46 (see FIG. 6) on the Detector-PCB 40, and from there are transferred to the Detector-PCB output connectors 54, the flex cables 52, the input connectors 56 of the multiplexer/amplifier unit 30, and finally they are processed in the multiplexer/amplifier unit 30 by well known to the art techniques. The data are then fed through output 70 to devices outside the vacuum chamber, where they may be further processed to provide mass spectrograms or be used for other functions.

In another embodiment of the present invention, better shown if FIG. 8A, the multiplexer or the combination multiplexer/amplifier resides on the first printed circuit board 40 in one or more of sections 30A, 30B and 30C.

In another embodiment of the present invention, better shown if FIG. 8B, the ion detector array assembly comprises one or more additional printed circuit boards, such as for example 30D and 30E, which may support circuitry, such as for example multiplexer and amplifier. The additional printed circuit boards are preferably disposed substantially parallel to and in the vicinity of the first printed circuit board 40. Spacers 64 are used to hold the printed circuit boards separated from each other, while connectors, such as for example electrical connectors 66 are used to transfer electrical signal from one board to the other board. These electrical connectors 66 may have a male portion on one board and a female portion on the respective board, in a manner that in addition to their function of transferring electrical signals, they also provide additional mechanical support and spacing. The output connector 70 may be utilized, as aforementioned, to transfer data to devices outside the vacuum chamber, where they may be further processed to provide mass spectrograms or be used for other functions, including, in the case of a CCD, to communicate with the CCD driver board which is also in the vacuum chamber and mounted below the base plate.

In a different embodiment of the instant invention, better illustrated in FIG. 8C, an electrical shield 68, surrounding the ion detector array assembly, may also be utilized to protect said assembly from stray electrical fields, produced for example by ions, electrons, etc., regardless of the number of printed circuit boards it contains.

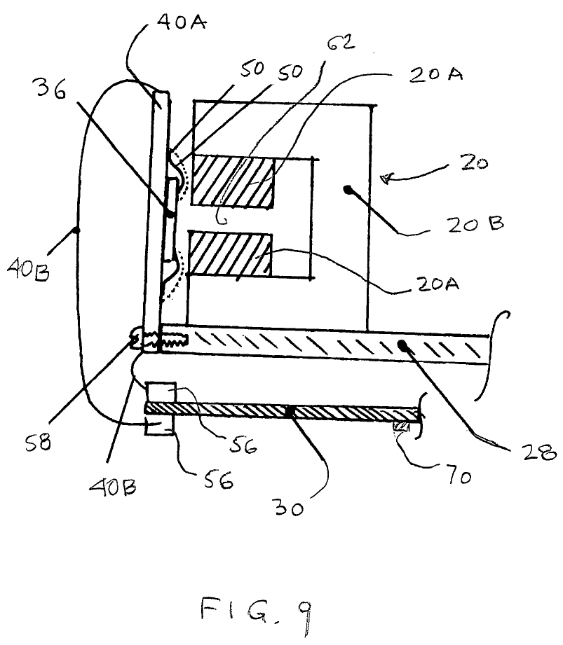

In still another embodiment of this invention, better illustrated in FIG. 9, the Detector-PCB is laid-out as a semi-flex board to incorporate the flex connectors needed to connect the Detector-PCB 40A to the PCB holding the multiplexer/amplifier 30. In this type of configuration, the flex cables 52 shown in FIG. 8 are replaced by the flexible portions 40B of the semi-flex Detector-PCB. It is highly preferable that the flexible portions 40B are shielded with conductive and grounded top layers.

As far as the other elements and the operation of the layout of FIG. 9 are substantially the same as in the case of the layout illustrated in FIG. 8.

In still other embodiments of the instant invention, the SCD array 36 in the layouts of FIGS. 8 and 9 may be replaced by a Faraday Cup Detector Array (FCDA) attached to the Detector-PCB 40 or 40A/40B, respectively. The operation of such embodiments is substantially similar to the one described in the previous embodiments with the difference that the sensitivity regarding signal strength and signal to noise ration are highly improved.

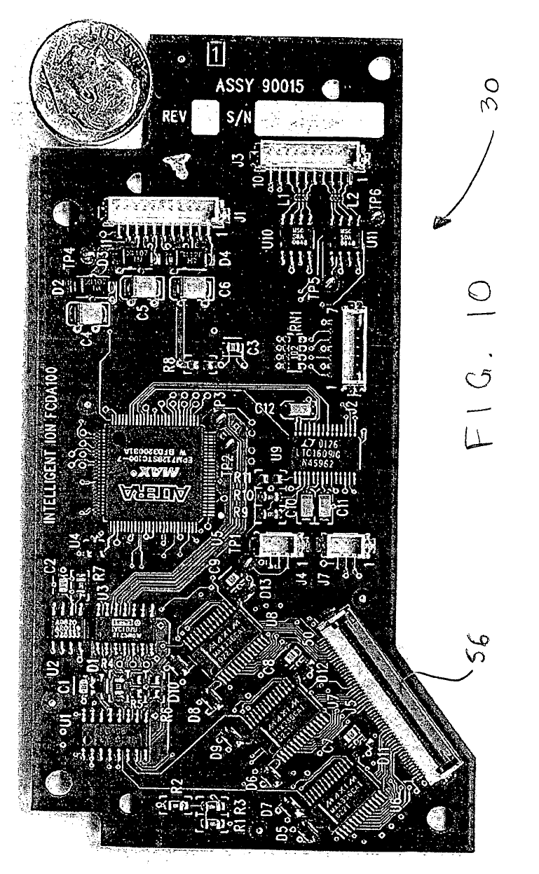

A magnified view of a FCDA-I/O-PCB multiplexer/amplifier unit is illustrated in FIG. 10. The dime on the upper right corner is present to demonstrate the degree of magnification.

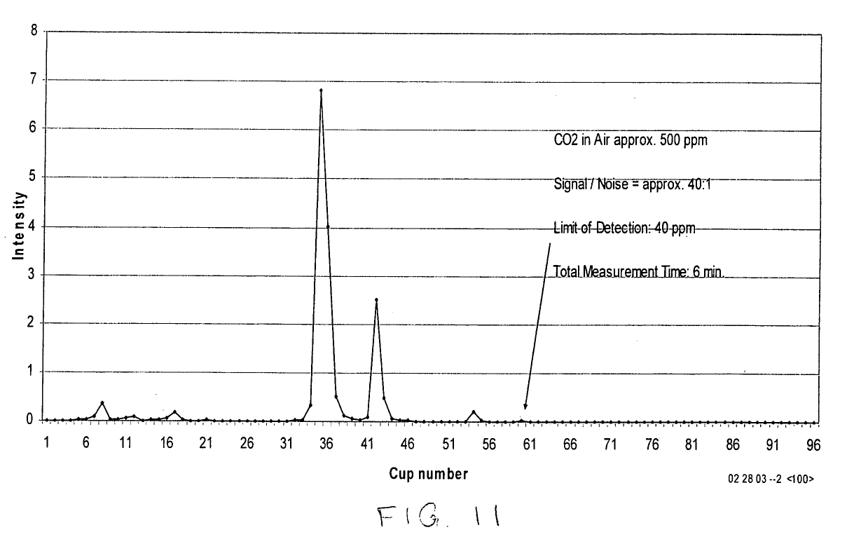

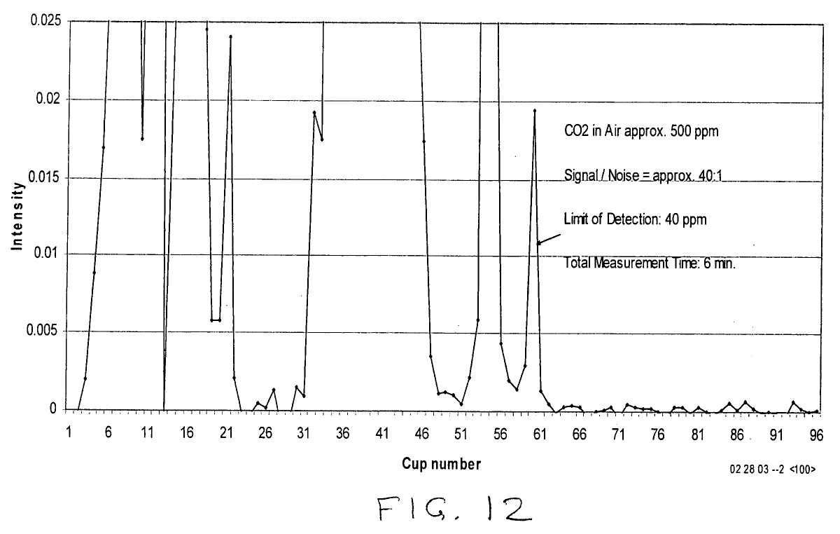

A typical spectrum measured with an instrument having a 1″ focal plane length is shown in FIGS. 11 and 12. The spectrum shows the expected composition of air. The CO2 peak is well resolved. It's intensity in a regular “office” environment is approximately 400 ppm. Thus, the instrument equipped with a 100 cup SCD has a limit of detection of approximately 40 ppm. FIG. 12 is a magnified version FIG. 11.

In the above described layouts utilizing either the SCD or FCDA arrays, said SCD or FCDA arrays 36 are physically separated from the multiplex/amplifier unit 30, as shown in FIGS. 8 and 9. This separation is disadvantageous to a certain degree, since it is prone to pick up noise along lines 52 (FIG. 8) or 40B (FIG. 9) from the first printed circuit board or Detector-PCB 40 (FIG. 8) or 40A/40B (FIG. 9), comprising the SCD or FCDA 36, to multiplexer connector 56. Thus, it is desirable to place the SCD 36 as well as multiplex/amplifier unit 30 as close as possible to each other, and more preferably onto the same chip. This can be achieved by utilizing a CCD camera-like shift register in place of a plain SCD 36. Such a shift register based direct ion detection system is disclosed and claimed in U.S. Pat. No. 6,576,899, as aforementioned.

Thus, according to this embodiment, the chip 36 is again mounted and connected to the first printed circuit board or Detector-PCB 40 (FIG. 8) or 40B (FIG. 9) and the signal flow is handed over to a next processing unit located inside or outside the vacuum chamber. The important fact is that the signal strength has been amplified considerably, substantially in situ, and only minimal noise (compared to the signal strength) may be picked during data transfer from the Detector-PCB 40 to any next processing unit. In this case, the Detector-PCB acts again as a mounting and electrical connecting tool.

The present invention also pertains Mass Spectrometers (MS), combination of Mass Spectrometers with other Mass Spectrometers (e.g., MS/MS), as well as combinations of Gas Chromatographs with Mass Spectrometers (e.g., GC/MS and GC/GC/MS) comprising the ion detector array assembly of this invention. The present invention is further related to various peripherals used in combination with Mass Spectrometers including without limitation auto sampling devices and electro-spray devices.

Although the embodiments presented above are referred to Strip Charge Detector Arrays, Faraday Cup Detector Arrays, and Shift Register Based Direct Ion Detection Chips, this invention pertains any type of ion detector arrays.

Examples of embodiments demonstrating the operation of the instant invention, have now been given for illustration purposes only, and should not be construed as restricting the scope or limits of this invention in any way.

Any feature(s) described in one of the exemplary embodiments may be combined with any features incorporated in any other exemplary embodiment according to this invention.

Any explanations given are speculative and should not restrict the scope of the claims.

The same numerals in different Figures represent the same or equivalent elements or functions.

What is claimed is:

1. A spectrometer assembly comprising:
a base plate;
a magnetic section mounted on the base plate and having an exit portion; and
a focal plane section disposed in front of the exit portion of the magnetic section, the focal section comprising an ion detector array assembly of a first printed circuit board mounted on the base plate and having traces, and an ion detector array attached to the first printed circuit board, the ion detector array having a plurality of ion sensing elements, wherein more than one of the ion sensing elements of the ion detector array are electrically connected to respective traces of the first printed circuit board directly or indirectly, thus rendering said respective traces active traces.

2. A spectrometer assembly as defined in claim 1, wherein the first printed circuit board further comprises a connector selected from a group of direct connector and indirect connector, the connector adaptable to connect or connecting active traces of the first printed circuit board with the input of a circuitry selected from a multiplexer and a combination of a multiplexer/amplifier.

3. A spectrometer assembly as defined in claim 1, wherein the ion detector array is a strip charge detector array.

4. A spectrometer assembly as defined in claim 1, wherein the ion detector array is a faraday cup detector array.

5. A spectrometer assembly as defined in claim 1, wherein the ion detector array is a shift register based direct ion detection chip.

6. A spectrometer assembly as defined in claim 2, wherein the ion detector array is a strip charge detector array.

7. A spectrometer assembly as defined in claim 2, wherein the ion detector array is a faraday cup detector array.

8. A spectrometer assembly as defined in claim 2, wherein the ion detector array is a shift register based direct ion detection chip.

9. A spectrometer assembly as defined in claim 1, wherein the first printed circuit board further comprises a circuit selected from a group of a multiplexer and a combination of multiplexer/amplifier connected to active traces of said first printed circuit board.

10. A spectrometer assembly as defined in claim 9, wherein the ion detector array is a strip charge detector array.

11. A spectrometer assembly as defined in claim 9, wherein the ion detector array is a faraday cup detector array.

12. A spectrometer assembly as defined in claim 9, further comprising a shield partially surrounding the first printed circuit board.

13. A spectrometer assembly as defined in claim 1, further comprising at least one additional printed circuit board disposed substantially parallel to and in the vicinity of the first printed circuit board and comprising a circuitry selected from multiplexer, amplifier, and combination of multiplexer/amplifier.

14. A spectrometer assembly as defined in claim 13, wherein the ion detector array is a strip charge detector array.

15. A spectrometer assembly as defined in claim 13, wherein the ion detector array is a faraday cup detector array.

16. A spectrometer assembly as defined in claim 13, further comprising a shield partially surrounding all printed circuit boards.

17. A device comprising a mass spectrometer of the Mattauch and Herzog type, the mass spectrometer comprising:
a base plate;
an ionizer mounted on the base plate;
an electrostatic energy analyzer in front of the ionizer and mounted on the base plate;
a magnetic section mounted on the base plate and having an exit portion; and
a focal plane section disposed in front of the exit portion of the magnetic section, the focal section comprising an ion detector array assembly of a first printed circuit board mounted on the base plate and having traces, and an ion detector array attached to the first printed circuit board, the ion detector array having a plurality of ion sensing elements, wherein more than one of the ion sensing elements of the ion detector array are electrically connected to respective traces of the first printed circuit board directly or indirectly, thus rendering said respective traces active traces.

18. A device as defined in claim 17, wherein the ion detector array is selected from a group of strip charge detector array, faraday cup detector array, and shift register based direct ion detection chip.

19. A device as defined in claim 17, wherein the first printed circuit board further comprises a circuit selected from a group of a multiplexer and a combination of multiplexer/amplifier connected to active traces of said first printed circuit board.

20. A device as defined in claim 19, wherein the assembly further comprises a shield partially surrounding the first printed circuit board.

21. A device as defined in claim 17, wherein the assembly further comprises at least one additional printed circuit board disposed substantially parallel to and in the vicinity of the first printed circuit board and comprising a circuitry selected from multiplexer, amplifier, and combination of multiplexer/amplifier.

22. A device as defined in claim 21, wherein the assembly further comprises a shield partially surrounding all printed circuit boards.

23. A device as defined in claim 17, further comprising a chromatograph connected to the mass spectrometer.

24. A device as defined in claim 18, further comprising a chromatograph connected to the mass spectrometer.

25. A device as defined in claim 19, further comprising a chromatograph connected to the mass spectrometer.

26. A device as defined in claim 20, further comprising a chromatograph connected to the mass spectrometer.

27. A device as defined in claim 21, further comprising a chromatograph connected to the mass spectrometer.

28. A device as defined in claim 22, further comprising a chromatograph connected to the mass spectrometer.
